(19) United States
(12) Patent Application Publication
(10) Pub. No.: US 2001/0020279 A1
(43) Pub. Date: Sep. 6, 2001

(54) Clock

(76) Inventor: Seppo Matias Alanara, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/741,806

(22) Filed: Dec. 22, 2000

(30) Foreign Application Priority Data
Dec. 29, 1999 (GB) 9930736.5

(51) Int. Cl. G06F 1/04; G06F 1/06

(52) U.S. Cl. 713/500

(57) ABSTRACT

A method for maintaining the accuracy of a clock, comprising the steps of setting the clock time on a first occasion; setting the clock time of on a second occasion; and adjusting the time-keeping operation of the clock on the basis of the time which elapsed between the first and second occasions, and the difference in clock time just prior to the second occasion and as set on the second occasion.

### BACKGROUND OF THE INVENTION

The present invention relates to maintaining the accuracy of a clock, and is especially, but not exclusively applicable to clocks within portable radio communication devices, such as radiotelephones.

It is well known for a radiotelephone to include time-keeping circuitry which enables it to serve additionally as a clock for the user. Often, the clock is driven from a crystal oscillator the output signal of which is also used as timing base for the other functions which the radiotelephone performs. Sometimes, a dedicated oscillator is provided to drive the clock. In either case, the stability of the output frequency of the oscillator has a great impact on the accuracy of the clock.

Many techniques are known to maintain the stability of the output frequency of the oscillator in the face of influences, such as temperature variation, ageing and the like, which tend to cause the output frequency to drift from its initial value. These known techniques generally increase the cost of the oscillator by, for example, using a more expensive and inherently more robust crystal and/or adding additional circuitry which attempts to compensate for the drift causing influences.

### SUMMARY OF THE INVENTION

With this background in mind, according to one aspect, the present invention may provide a method for maintaining the accuracy of a clock, comprising the steps of: setting the clock time on a first occasion; setting the clock time of on a second occasion; and adjusting the time-keeping operation of the clock on the basis of the time which elapsed between the first and second occasions, and the difference in clock time just prior to the second occasion and as set on the second occasion.

In this way, the accuracy of the clock can be maintained within reasonable bounds in the face of drift-causing influences, not by increasing the cost or complexity of the clock circuitry itself to arrive at the required accuracy, but by using feedback from an external, more accurate source to adjust the time-keeping operation of the clock to compensate for the drift-causing influences.

Preferably, the clock comprises an oscillator and processing means for processing the signal from the oscillator on the basis of a timing parameter to produce an indication of clock time.

In one embodiment, the time-keeping operation of the clock may be adjusted by directly re-tuning the crystal of the oscillator. Alternatively or additionally, the timing parameter of the processing means may be adjusted.

The clock time may be set manually by the user. Alternatively, where the clock is implemented as part of a radio communication device, it can be automatically reset from time to time from an accurate remote source via the radio interface.

In other embodiments, the clock cannot only passively adjust its time-keeping operations to adjust to past conditions, but can also based on predictive models of the behaviour of the oscillator in different environments temperature-wise, the behaviour of the oscillator as it ages and the like, the clock can also seek to pre-compensate for frequency drift before or as it is happening.

According to a further aspect of the invention, the present invention may provide a clock comprising time-setting means to set the clock time; and adjustment means for adjusting the time-keeping operation of the clock when the clock time is reset.

Preferably, the clock comprises an oscillator and processing means to process the signal from the oscillator on the basis of a timing parameter to produce an indication of clock time.

In one embodiment, the adjustment means includes means for re-tuning the oscillator. Alternatively or additionally, the adjustment means is operable to adjust the timing parameter.

According to a further aspect of the invention, the present invention may provide a radio communication device including a clock as previously discussed.

### BRIEF DESCRIPTION OF THE DRAWINGS

Exemplary embodiments of the invention are hereindescribed with reference to the accompanying drawings, in which:

FIGS. 1(a) and 1(b) show schematic hardware layouts for first and second embodiments of the invention, respectively;

FIG. 2 is a time line illustrating the present invention; and

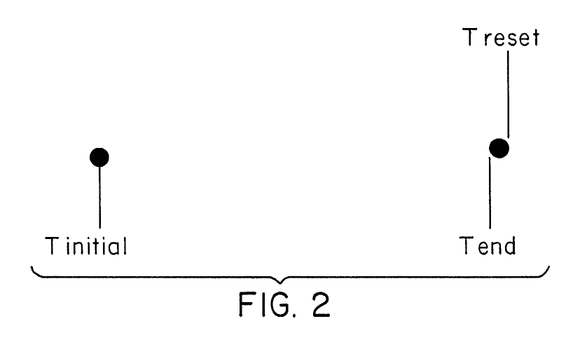

FIG. 3 is a view of an embodiment of FIG. 1 communicating with a base station and the internet.

### DETAILED DESCRIPTION OF THE INVENTION

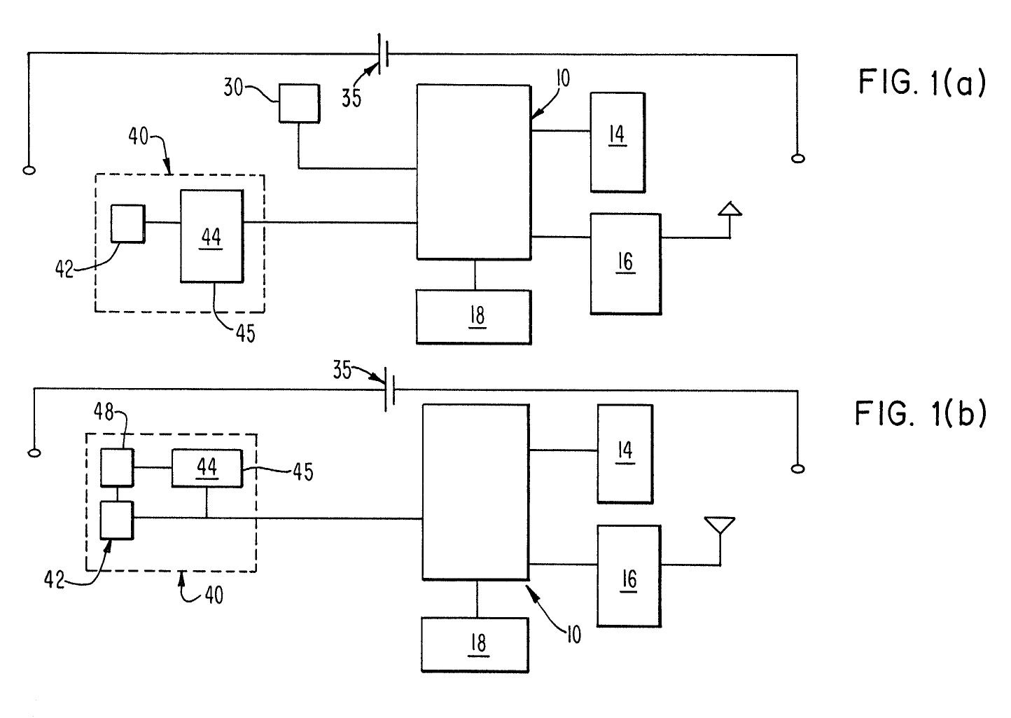

Referring to FIG. 1(a), a cellular radiotelephone 1 in accordance with a first embodiment of the present invention is shown. The radiotelephone comprises a baseband unit 10 for controlling the general operation of the radiotelephone. The baseband unit 10 is also coupled to a display 14, a radio interface 16 by which the telephone can communicate over the air with a base station, a key pad 18. The timing base for the baseband unit 10 is provided by a crystal oscillator 30. Also, a clock unit 40 also supplies clock time data to the baseband unit 10 which depending on the mode in which the radiotelephone is being used can be displayed on the display 14. The clock unit 40 includes a dedicated crystal oscillator 42 which produces an output signal at a nominal frequency f after it has been tuned during manufacture. The clock unit 40 also comprises a processing unit 44 which keeps time in clock time format, i.e., date/hours/minutes, and counts the pulses produced by the oscillator 42 to provide an indication of the passage of time so that the clack time be appropriately updated. The processing unit 44 also includes semi-permanent memory 45. The clock time held by the processing means can be set from the user via the key pad 18. The radiotelephone is powered from a removable battery power supply 35. When the battery power is removed, the oscillator clock unit 40 continues to operate normally for a short while deriving its power from a large capacitor (not shown). Once the capacitor runs down the clock unit 40 stops operating.

As the radiotelephone leaves the manufacturing process, the nominal frequency of the oscillator is accurately known. Therefore, the processing unit 44, having a timing parameter P set equal to f, is able to count P pulses and equate that duration with one second (because P=f) and hence accurately update its clock time. So when the user initially gets the radiotelephone and sets the clock time via the key pad, the radiotelephone is able to accurately keep time. When the clock time is initially set, this time, Tᵢₙᵢₜᵢₐₗ, is stored in the semi-permanent memory 45. Timing parameter P is also stored in the semi-permanent memory 45. As time goes by, the effects of the climate in which the radiotelephone is being used, the ageing of the oscillator 42 and the like, causes the actual output of the oscillator 42 to drift+Δf. As a result, when the processing unit 44 counts P=f pulses, this no longer equates exactly to one second and so the clock time shown by the radiotelephone incrementally diverges from the actual time.

When the user resets the time, at time T_{end}, because he has noted that the displayed time is no longer correct, the processing unit 44 calculates (1) t_{period}, the time since the clock time was last reset, T_{end}−Tᵢₙᵢₜᵢₐₗ, and (ii) ΔT calculates the difference in clock time as the clock is reset, Tᵣₑₛₑₜ, and the clock time momentarily before the clock time is reset, T_{end}. By calculating t_{periods}, ΔT, the processing unit 44 can then evaluate the average error per unit time over the interval Tᵣₑₛₑₜ and make a correction to the timing parameter P to reflect this error.

In this way, the processing unit 44 seeks to use the knowledge of the time-keeping error made over the interval t_{period} to adjust the time-keeping operation of the clock unit 40 to keep time more accurately in the future.

This corrective process is applied every time the user resets the clock time. From the foregoing, it will be appreciated that Tᵣₑₛₑₜ for one interval becomes Tᵢₙᵢₜᵢₐₗ for the next interval.

In FIG. 1(b), in which similar parts have been given the same reference numbers, a radiotelephone 1 in accordance with a second embodiment of the present invention is shown. This embodiment differs from the first embodiment in that the oscillator 30 for driving the baseband unit is dispensed with and, instead, the clock oscillator 42 is used to provide the time base for baseband unit 10 also. In addition, the clock unit 40 includes an oscillator tuning unit 40.

The operation of this embodiment is the same as the first FIG. 1(a) embodiment except on the basis of the calculated values Of t_{period} and ΔT, the oscillator tuning unit re-tunes the output frequency of the oscillator 44.

It will be appreciated that an added advantage of this second embodiment of the invention is that the frequency output of the oscillator 42 is brought back towards its nominal value f and this is advantageous to the reliability of the operation of the rest of the radiotelephone.

In both embodiments, because the adjust of the time-keeping operation of the clock unit 40 depends on Tᵢₙᵢₜᵢₐₗ which is stored in the memory 45, Tend and Tᵣₑₛₑₜ, it is important to try and identify situations in which the battery for a prolonged has been removed or where the clock time entered by the user is erroneous. It will be clear that if these eventualities are not recognized then it will be possible that the operation of the clock unit will be severely distorted and bear little resemblance to the passage of actual time. This is particularly serious in the case of the second embodiment, where the effect of the error will not be localized to the clock unit 40 itself, but also affect the operation of the other functions of the radiotelephone.

Where the battery is removed for a prolonged period, only the data in the semi-permanent memory will be retained. On powering up the radiotelephone again, the clock time will assume a zero default status. As the clock time includes a date field as well this condition will be very easy to detect as a zero day or month does not exist normally. Where the user enters an erroneous clock time, this can be detected by setting a threshold for ΔT above which it is assumed that there has been a user error. In both these cases, the time-keeping operation of the clock unit 44 is not adjusted.

Another situation in which the time-keeping operation might not be adjusted is where t_{period} is a very short period.

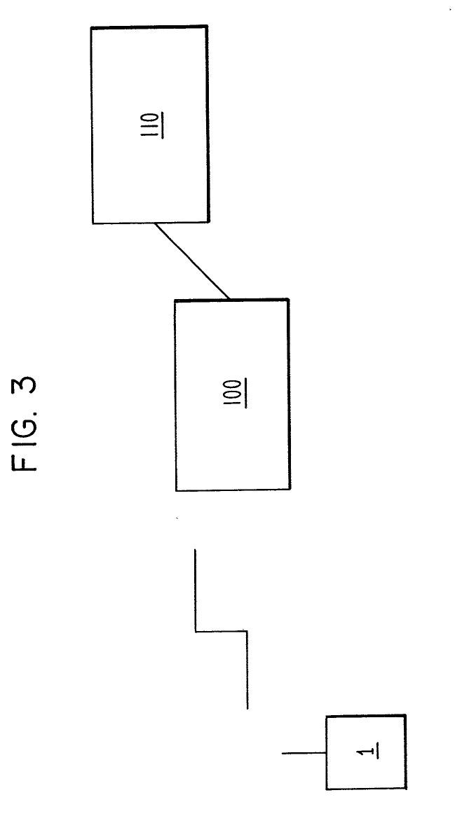

In other embodiments of the invention and referring to FIG. 3, the radiotelephone 1 automatically requests an accurate version of clock time from a base station 100 of a cellular network, or from the internet 110 which it gains access to via the base station 110. In other embodiments, the base station 100 can regularly update the radiotelephone 1 with the correct clock time which it supplies from its own accurate clock or which it requests from the internet 110.

In other embodiments, the radio telephone 1 cannot only passively adjust its time-keeping operations to adjust to pas conditions, but can also based on predictive models of the behaviour of the oscillator in different environments temperature-wise, the behaviour of the oscillator as it ages and the like, the clock can seek to pre-compensate for frequency drift before or as it is happening.

What is claimed is:

1. A method for maintaining the accuracy of a clock, comprising the steps of:
setting the clock time on a first occasion;
setting the clock time of on a second occasion; and
adjusting the time-keeping operation of the clock on the basis of the time which elapsed between the first and second occasions, and the difference in clock time just prior to the second occasion and as set on the second occasion.

2. A method as in claim 1, wherein the clock comprises an oscillator and processing means for processing the signal from the oscillator on the basis of a timing parameter to produce an indication of clock time.

3. A method as in claims 1 or 2, wherein the time-keeping operation of the clock is adjusted by re-tuning the frequency of the oscillator.

4. A method as in claim 2, wherein the timing parameter of the processing means is adjusted.

5. A method as in any preceding claim, wherein the setting of the clock time is performed by the user.

6. A method as in any of claims 1 to 5, when the clock forms part of the radio device, wherein clock time is set by a remote time reference via the 3d radio interface of the radio device.

7. A clock suitable for a radio communication device comprising time-setting means to set the clock time of the processing means; and
adjustment means for adjusting the time-keeping operation of the clock when the clock time is reset.

8. A clock as in claim 7, comprising an oscillator and processing means to process the signal from the oscillator on the basis of a timing parameter to produce an indication of clock time.

9. A clock as in claims 7 or 8, wherein the adjustment means includes means for re-tuning the oscillator.

10. A clock as in claims 8 or 9, wherein the adjustment means is operable to adjust the timing parameter.

11. A clock as in claims 7 to 10, including means to adjust the time keep-operation of the clock based on predictive models of the behaviour of the components of the clock.

12. A portable radio communication device having a radio interface and including a clock as in any of claims 7 to 11, further comprising means for obtaining an accurate time reference by which to set the clock time via the radio interface.
